(19) United States
(12) Patent Application Publication
(10) Pub. No.: US 2020/0246889 A1
(43) Pub. Date: Aug. 6, 2020

(54) REAMER HEAD WITH FLUTE GEOMETRY AND METHOD OF MAKING SAME

(71) Applicant: Kennametal Inc., Latrobe, PA (US)

(72) Inventors: Li Ning, Pleasant Unity, PA (US); Michael Hacker, Nuernberg (DE); Paul Brown, Hostetter, PA (US); Tom Bobos, Morton Grove, IL (US); Bettina Wagner, Wernberg-Koblitz (DE)

(73) Assignee: Kennametal Inc., Latrobe, PA (US)

(21) Appl. No.: 16/268,747

(22) Filed: Feb. 6, 2019

(51) Int. Cl. B23D 77/00; B24B 19/00

(52) U.S. Cl. CPC B23D 77/006; B24B 19/00

(57) ABSTRACT

A reamer head for a reamer includes one or more blades separated by flutes. Each flute has a front core region proximate a front end of the cutting portion, a rear portion proximate a rear end of the cutting portion and the middle core region therebetween. The front core region has a thickness, T1, the middle core region has a thickness, T2, and the rear core region has a thickness, T3. The thickness, T2, of the middle core region is greater than the thickness, T1, of the front core region and the thickness, T3, of the rear core region. A method of making the reamer head is also disclosed.

### BACKGROUND OF THE INVENTION

Known rotary cutting tools for performing reaming operations, such as a reamer, typically comprise a cutting head having an axis of rotation. The cutting head has a forward end and a peripheral surface extending rearwardly therefrom. The peripheral surface includes at least two cutting inserts or blades extending rearwardly from the forward end and separated by a chip flute for the evacuation of chips produced during the cutting operation.

Some conventional cutting head designs push the chips forward, through the hole using radial coolant in the flutes directed toward the cutting edges. However, the natural chip flow of the material, combined with the cutting geometry, causes the chip to want to flow backward directly into the chip flute during the cutting operation. This is not ideal because the chips may become tangled on the tool shank and/or remain in the machined holes during the cutting operation, thereby blocking any coolant from reaching the cutting edge.

### SUMMARY OF THE INVENTION

The problem of inadequate coolant flow to the cutting edges in a cutting tool performing a reaming operation is solved by providing a reamer head with a flute geometry having three core regions: a front core region, a middle core region and a rear core region.

In one aspect, a reamer comprises a shank portion and a cutting portion extending from the shank portion. The cutting portion includes one or more blades separated by flutes. Each flute comprises a front core region proximate a front end of the cutting portion, a rear portion proximate a rear end of the cutting portion and the middle core region therebetween. The front core region has a thickness, T1, the middle core region has a thickness, T2, and the rear core region has a thickness, T3. The thickness, T2, of the middle core region is greater than the thickness, T1, of the front core region and the thickness, T3, of the rear core region.

In another aspect, an annular reamer head for a reamer comprises one or more blades separated by flutes. Each flute comprises a front core region proximate a front end of the cutting portion and a rear portion proximate a rear end of the cutting portion, wherein the rear core region includes an angled wall for directing coolant within each flute.

In yet another aspect, a method of making a reamer head comprises:

grinding a cylindrical blank to form a middle core region of a flute;

grinding the cylindrical blank to form a front core region of the flute after grinding the middle core region; and

grinding the cylindrical blank to form a rear core region of the flute after grinding the middle core region.

### BRIEF DESCRIPTION OF THE DRAWINGS

While various embodiments of the invention are illustrated, the particular embodiments shown should not be construed to limit the claims. It is anticipated that various changes and modifications may be made without departing from the scope of this invention.

FIG. 1 is a side view of a multi-flute reamer with a reamer head according to an embodiment of the invention;

FIG. 2 is an enlarged view of the multi-flute reamer with the reamer head of the invention;

FIG. 3 is an end view of the multi-flute reamer and the reamer head of FIG. 1;

FIG. 4 is a front isometric view of the reamer head according to an embodiment of the invention;

FIG. 5 is a side view of the reamer head of FIG. 4;

FIG. 6 is a cross-sectional view of the reamer head taken along line 6-6 of FIG. 5;

FIG. 7 is a cross-sectional view of the reamer head taken along line 7-7 of FIG. 5;

FIG. 8 is a cross-sectional view of the reamer head taken along line 8-8 of FIG. 5;

FIG. 9 is a schematic view of a flute wheel for grinding the flute in the reamer head of the invention;

FIGS. 10(a) and 10(b) show the method of forming the middle core region of the flute in the reamer head of the invention;

FIGS. 11(a) and 11(b) show the method of forming the rear core region of the flute in the reamer head of the invention; and

FIGS. 12(a) and 12(b) show the method of forming the front core region of the flute in the reamer head of the invention.

### DETAILED DESCRIPTION OF THE INVENTION

Below are illustrations and explanations for a version of a cutting tool, such as an orbital drill, and the like, with both right-handed helical or spiral flutes and left-handed helical or spiral flutes for machining a workpiece (not shown) made of multiple materials. However, it is noted that the cutting tool may be configured to suit any specific application, such as reaming, end milling, and the like, and is not limited only to the example in the illustrations.

The description herein of specific applications should not be a limitation on the scope and extent of the use of the cutting tool.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Throughout the text and the claims, use of the word “about” in relation to a range of values (e.g., “about 22 to 35 wt %”) is intended to modify both the high and low values recited, and reflects the penumbra of variation associated with measurement, significant figures, and interchangeability, all as understood by a person having ordinary skill in the art to which this invention pertains.

For purposes of this specification (other than in the operating examples), unless otherwise indicated, all numbers expressing quantities and ranges of ingredients, process conditions, etc are to be understood as modified in all instances by the term “about”. Accordingly, unless indicated to the contrary, the numerical parameters set forth in this specification and attached claims are approximations that can vary depending upon the desired results sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Further, as used in this specification and the appended claims, the singular forms “a”, “an” and “the” are intended to include plural referents, unless expressly and unequivocally limited to one referent.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements including that found in the measuring instrument. Also, it should be understood that any numerical range recited herein is intended to include all sub-ranges subsumed therein. For example, a range of “1 to 10” is intended to include all sub-ranges between and including the recited minimum value of 1 and the recited maximum value of 10, i.e., a range having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

In the following specification and the claims, a number of terms are referenced that have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

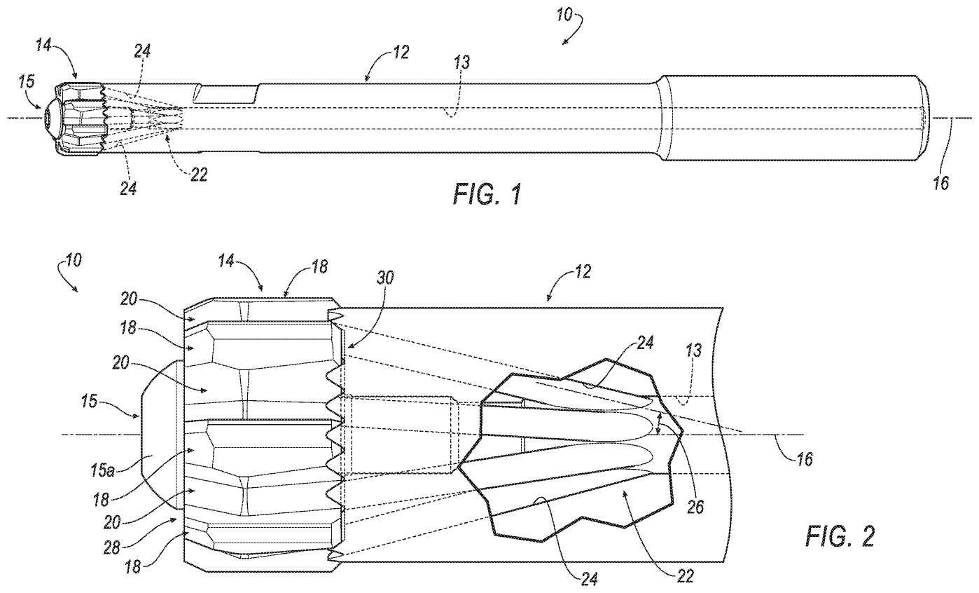

Referring to FIGS. 1-3, wherein like reference characters represent like elements, a cutting tool, such as a reamer, is generally shown at 10, according to an embodiment of the invention. In general, the multi-flute reamer 10 includes a shank portion 12, an annular cutting portion 14 extending from the shank portion 12 and a central, longitudinal axis 16. In the illustrated embodiment, the cutting portion 14 comprises a reamer head that is attached to the shank portion 12 by using a threaded fastener 15, such as a mounting screw, and the like. In the illustrated embodiment, the mounting screw 15 has a rounded head 15a to aid in chip evacuation. The shank portion 12 is capable of being received in a conventional machine tool holding chuck (not shown). The shank portion 12 includes a longitudinal coolant cavity 13 for allowing coolant and lubricant to pass therethrough.

The cutting portion 14 includes a plurality of blades 18 separated by flutes 20 extending the length of the cutting portion 14. In the illustrated embodiment, the reamer 10 has a total of eight blades 18 and flutes 20. However, it will be appreciated that the invention is not limited by the number of blades and flutes, and that the invention can be practiced with a fewer or a greater number of blades and flutes, depending on the design geometry of the cutting tool.

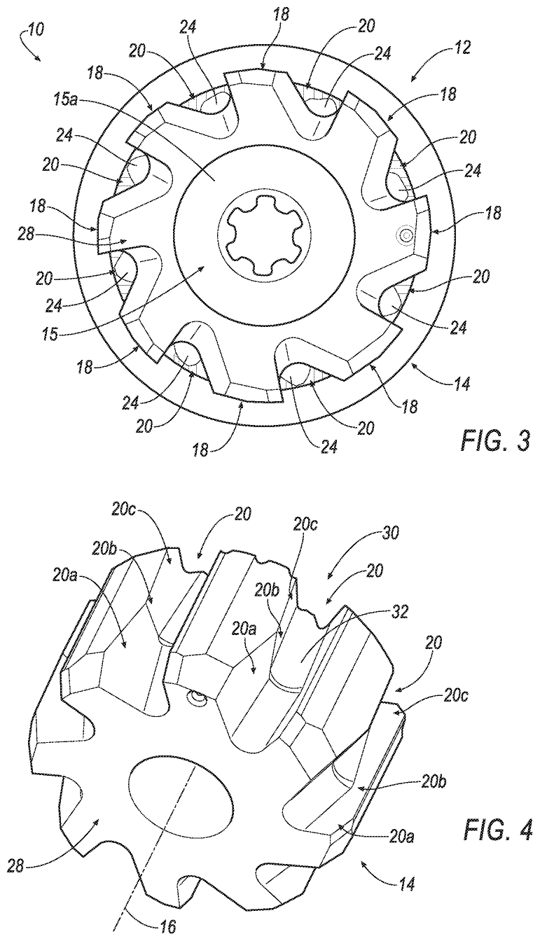

The shank portion 12 of the reamer 10 includes a coolant header 22 in fluid communication with the longitudinal coolant cavity 13 that provides coolant, lubricant, and the like, to a plurality of coolant outlet channels 24. In the illustrated embodiment, there is a one-to-one correspondence between the number of flutes 20 and the number of coolant outlet channels 24. Thus, the reamer 10 of the illustrated embodiment has a total of eight coolant outlet channels 24 for providing fluid, such as coolant, lubricant, and the like, to the blades 18 of the reamer 10 (as indicated by the arrow in FIG. 2). As shown in FIGS. 2 and 3, each coolant outlet channel 24 is located so as to provide coolant within each flute 20 toward the front end 28 of the cutting portion 14 and the cutting zone. In addition, each outlet channel 24 is formed at an angle 26 in the range between about 15 degrees and about 60 degrees with respect to the central, longitudinal axis 16 of the reamer 10. However, it will be appreciated that the invention is not limited by the angle 26 of the coolant outlet channel 24, and that the invention can be practiced with any desirable angle that provides optimum supply of coolant and lubricant to the blades 18.

Referring now to FIGS. 4-8, the reamer head 14 is shown according to an embodiment of the invention. One aspect of the invention is that at least one flute 20 of the reamer head 14 has a flute geometry comprising a front core region 20a, a middle core region 20b and a rear core region 20c. The front core region 20a rearwardly extends from a front end 28 of the reamer head 14 to the middle core region 20b and the rear core region 20c forwardly extends from a rear end 30 of the reamer head 14 to the middle core region 20b.

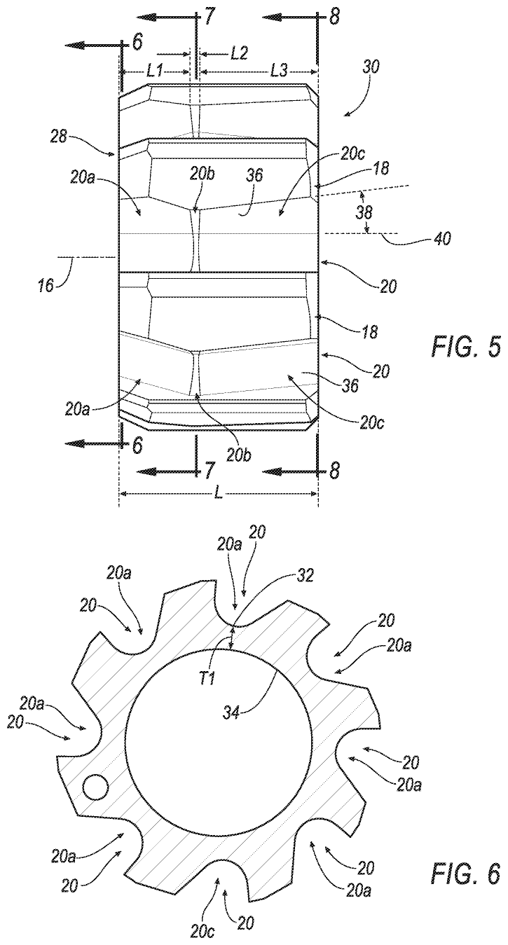

As seen in FIG. 5, the front core region 20a has a length, L1, between about 20-60% of the total length, L, of the reamer head 14. The middle core region has a length, L2, between about 0-60% of the total length, L, and the rear core region 20c has a length, L3, between about 20-60% of the total length, L, of the reamer head 14. Thus, in an alternate embodiment, the middle core region 20b can be eliminated (i.e., having a length, L2, equal to zero) and the reamer head 14 has only the front core region 20a and the rear core region 20c. In this embodiment, the front core region 20a can have a length, L1, between about 40-60% of the total length, L, and the rear core region 20c can have a length, L3, between about 40-60% of the total length, L.

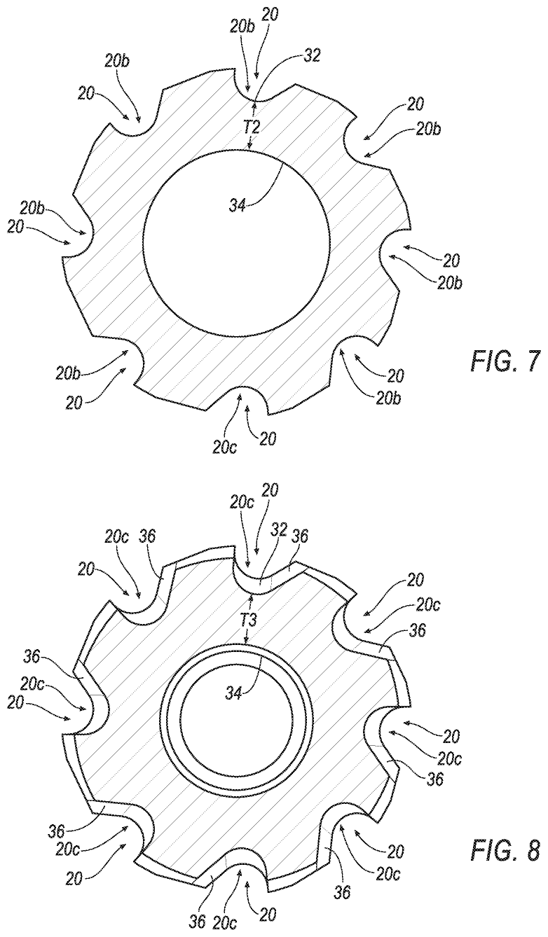

By comparing FIGS. 6 and 7, it can be seen that the front core region 20a is wider than the middle core region 20b. The function of the relatively wider front core region 20a is to provide an enlarged area for chip evacuation for the reamer 10. It should be noted that the front core region 20a has a thickness, T1, between a bottom 32 of the flute 20 and an inner wall 34 of the reamer head 14 that is smaller than a thickness, T2, between the bottom 32 and the inner wall 34 of the middle core region 20b. It will be appreciated that the magnitude of the thickness, T1, of the front core region 20a and the magnitude of the thickness, T2, of the middle core region 20b can vary, depending on the diameter of the multi-flute reamer 10. For example, the thickness, T1, of the front core diameter 20a and the thickness, T2, of the middle core region 20b will be larger for a reamer head having a relatively larger diameter, and vice versa.

As shown in FIG. 8, the rear core region 20c has a substantially planar sidewall 36 extending from the rear end 30 of the reamer head 10 toward the middle core region 20b. The sidewall 36 is formed at an angle 38 with respect to an axis 40 that is substantially parallel to the central, longitudinal axis 16 of the multi-flute reamer 10. The purpose of the angled sidewall 36 is to more efficiently direct coolant, lubricant, and the like, exiting from the coolant outlet channel 24 to the cutting zone proximate the front end 28 of the reamer head 14. The angle 38 can be in the range between about 15 degrees and about 60 degrees with respect to the axis 40.

It should be noted that the rear core region 20c has a thickness, T3, that is relatively smaller than the thickness, T2, of the middle core region 20b. Thus, the middle core regions 20b has a thickness, T2, that is greater than both the front core region 20a and the rear core region 20c. The purpose of the relatively larger thickness, T2, of the middle core region 20b is to provide relatively stronger blades 18, as compared to blades having a smaller thickness. The magnitude of the thickness, T3, of the rear core region 20c may not vary as a function of the diameter of the reamer head 10, especially if the reamer head can be mounted in the same machine tool holding chuck (not shown). It should also be noted that varying the thickness, T2, of the middle core region 20b, while maintaining a constant thickness, T3, of the rear core region 20c will result in a change in the angle in which the coolant is delivered to the cutting zone. Thus, the coolant angle can be optimized by varying the thickness, T2, of the middle core region 20b, while maintaining the thickness, T3 of the rear core region 20c constant.

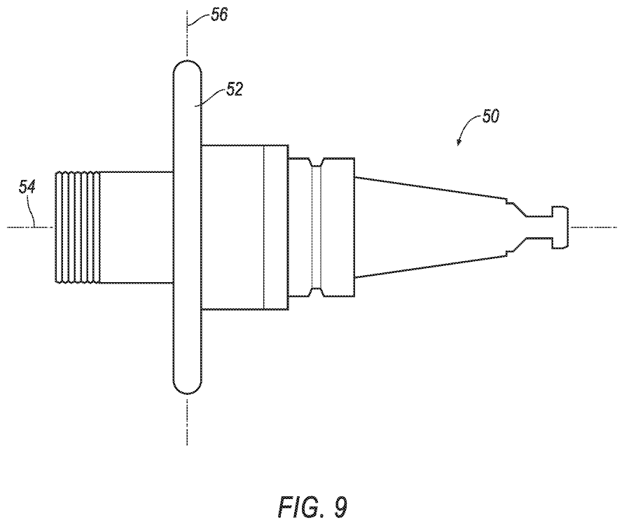

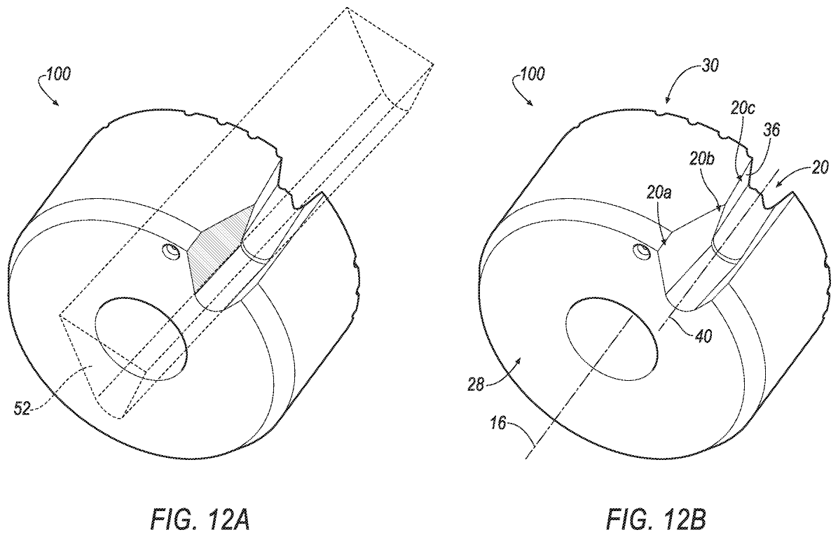

Referring now to FIGS. 9-12, a method of making the reamer head 14 of the invention will now be described. Referring now to FIG. 9, a flute wheel, shown generally at 50, includes a circular, disc-shaped flute grinding wheel 52. The flute wheel 50 is rotated about a rotational axis 54 that is generally transverse to an axis, X, of a cylindrical blank 100.

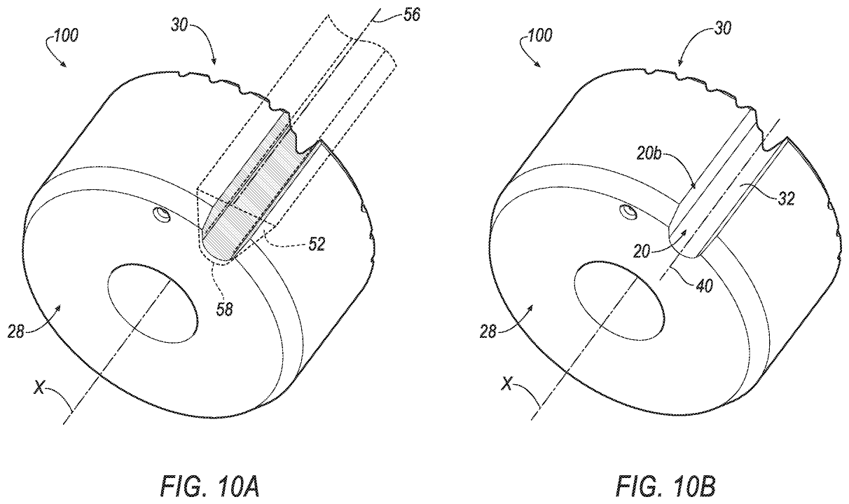

The flute 20 of the reamer head 14 of the invention is basically formed using a single path grinding process in which the grinding wheel 52 is driven about the rotational axis 54 of the grinding wheel 52 at a relatively high speed of about 3,500 rpm to about 5,000 rpm, while the grinding wheel 52 is moved along a line parallel to the axis, X, of the cylindrical blank at a linear speed of about 1-2 inches per minute. Linear movement of the grinding wheel 52 may begin at the front end 28 of the cylindrical blank 100 and advances to the rear end 30 of the cylindrical blank 100, as shown in FIG. 10(a). Alternatively, the grinding wheel 52 may begin at the rear end 30 of the cylindrical blank 100 and advances to the front end 28 of the cylindrical blank 100. Linear motion of the grinding wheel 52 parallel to the longitudinal axis, X, of the cylindrical blank 100 results in the middle core region 12b being formed in the cylindrical blank 100, as shown in FIG. 10(b).

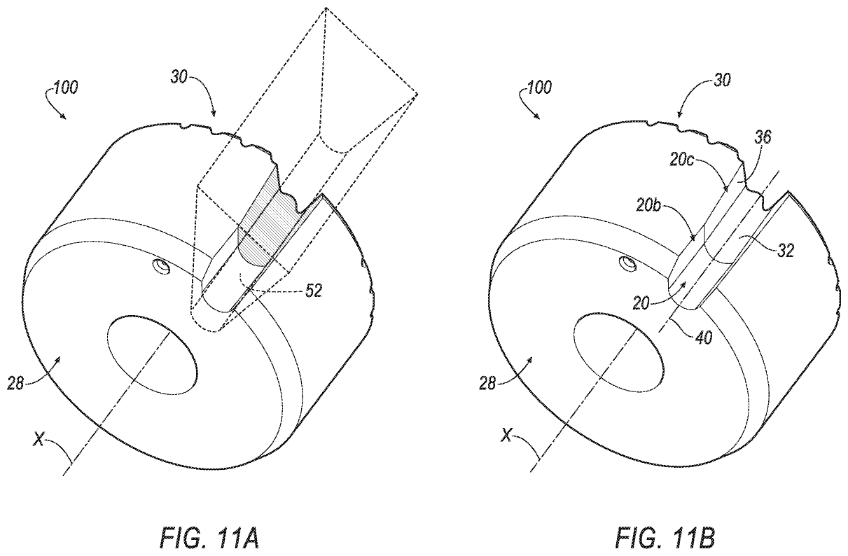

Next, the grinding wheel 52 is tilted upward at an angle between about 5 degrees and about 35 degrees with respect to the plane 40 that is substantially parallel to the axis, X, of the cylindrical blank 100, as shown in FIG. 11(a). Linear movement of the grinding wheel 52 begins at the rear end 30 of the cylindrical blank 100 and advances to the middle core region 20b formed in the earlier step. As a result, the rear core region 20c of the flute 20 is formed in the cylindrical blank 100, as shown in FIG. 11(b). In addition, the grinding wheel 52 may be tilted at an angle that results in the angled sidewall 36 being formed in the rear core region 20c.

Then, grinding wheel 52 is tilted downward at an angle between about 5 degrees and about 35 degrees with respect to the plane 40 that is substantially parallel to the axis, X, of the cylindrical blank 100. Linear movement of the grinding wheel 52 begins at the front end 28 of the cylindrical blank 100 and advances to the middle core region 20b formed in the earlier step. As a result, the front core region 20a of the flute 20 is formed in the cylindrical blank 100. At this point, the flute 20 with the front core region 20a, the middle core region 20b and the rear core region 20c is completely formed using a single grinding wheel 52. As a result, the cost of manufacturing the reamer head 14 is greatly reduced.

It should be appreciated that the invention is not limited by the order in which the rear core region 20c and the front core region 20a are formed, and that the invention can be practiced with forming the front core region 20a prior to forming the rear core region 20c.

The patents and publications referred to herein are hereby incorporated by reference.

Having described presently preferred embodiments the invention may be otherwise embodied within the scope of the appended claims.

What is claimed is:

1. A reamer, comprising:
a shank portion; and
a cutting portion extending from the shank portion, the cutting portion including one or more blades separated by flutes, each flute comprising a front core region proximate a front end of the cutting portion, a rear portion proximate a rear end of the cutting portion and the middle core region therebetween, the front core region having a thickness, T1, the middle core region having a thickness, T2, and the rear core region having a thickness, T3, wherein the thickness, T2, of the middle core region is greater than the thickness, T1, of the front core region and the thickness, T3, of the rear core region.

2. The reamer of claim 1, wherein the cutting portion comprises an annular reamer head.

3. The reamer of claim 1, wherein the rear core region includes an angled wall for directing coolant within each flute.

4. The reamer of claim 1, wherein the front core region is wider than the middle core region.

5. The reamer of claim 1, wherein shank portion includes a coolant header in fluid communication with a longitudinal coolant cavity for providing coolant to a plurality of coolant outlet channels.

6. The reamer of claim 5, wherein each coolant channel is formed at an angle in a range between about fifteen degrees and about sixty degrees with respect to a central, longitudinal axis of the reamer.

7. The reamer of claim 5, wherein there is a one-to-one correspondence between a number of flutes and a number of coolant outlet channels.

8. An annular reamer head for a reamer comprising one or more blades separated by flutes, each flute comprising a front core region proximate a front end of the cutting portion and a rear portion proximate a rear end of the cutting portion, wherein the rear core region includes an angled wall for directing coolant within each flute.

9. The reamer head of claim 8, further comprising a middle core region between the front core region and the rear core region, wherein the front core region has a thickness, T1, and the rear core region has a thickness, T3, and wherein the middle core region has a thickness, T2, greater than the thickness, T1, of the front core region and the thickness, T3, of the rear core region.

10. The reamer head of claim 9, wherein the front core region is wider than the middle core region.

11. A method of making a reamer head, comprising:
grinding a cylindrical blank to form a middle core region of a flute;
grinding the cylindrical blank to form a front core region of the flute after grinding the middle core region; and
grinding the cylindrical blank to form a rear core region of the flute after grinding the middle core region.

12. The method of claim 11, wherein the front core region is formed prior to forming the rear core region.

13. The method of claim 11, wherein the rear core region is formed prior to forming the front core region.

14. The method of claim 11, wherein the front core region having a thickness, T1, the middle core region having a thickness, T2, and the rear core region having a thickness, T3, wherein the thickness, T2, of the middle core region is greater than the thickness, T1, of the front core region and the thickness, T3, of the rear core region.
